(19) United States
(12) Patent Application Publication
(10) Pub. No.: US 2003/0187797 A1
(43) Pub. Date: Oct. 2, 2003

(54) Method for issuing and settling electronic check

(76) Inventors: Sang-Hern Song, Daejeon-si (KR); Ki-Young Baek, Nonsan-si (KR); Jae-Cheol Ryou, Daejeon-si (JP); Jong-Hu Lee, Daejeon-si (KR)

Correspondence Address: PENNIE & EDMONDS LLP, 1667 K STREET NW, SUITE 1000, WASHINGTON, DC, 20006

(21) Appl. No.: 10/309,353

(22) Filed: Dec. 4, 2002

(30) Foreign Application Priority Data
Mar. 29, 2002 (KR) 2002-17545

(51) Int. Cl. G06F 17/60

(52) U.S. Cl. 705/45

(57) ABSTRACT

A method for issuing and settling an electronic check. An electronic check management server includes a user registration module, an electronic check issuance module, and an electronic check settlement module that are respectively executable by software. An issuer computer includes a user registration module and an electronic check issuance module that are respectively executable by software. A payee computer includes a user registration module and an electronic check settlement module that are respectively executable by software. Therefore, the method adopts a client as an electronic check issuer to quickly issue the electronic check, and transmits an issued electronic check to a payee via an E-mail using a P2P method, thereby establishing secure remittance/settlement services.

### BACKGROUND OF THE INVENTION

1. Field of the Invention

The present invention relates to a method for issuing and settling an electronic check, and more particularly to a method for issuing an electronic check over the Internet, and settling the issued electronic check.

2. Description of the Related Art

Conventional electronic financial settlement systems have settled the amount of money charged for commodity purchase or service usage using various kinds of settlement methods, for example, a transfer account service over the Internet or a settlement service using one of a cyber money, a credit card and electronic cash. But, such a conventional electronic financial settlement system has a disadvantage in that personal information and financial information are undesirably exposed to unspecified people. To obviate this disadvantage, new settlement techniques related to an electronic check are increasingly introduced to the market.

A representative settlement technique related to such electronic check using the Internet is described in Korean Patent Laid-open Publication No. 2001-81876, entitled “ELECTRONIC CHECK PAYMENT SYSTEM FOR ELECTRONIC COMMERCE OVER INTERNET” published on Aug. 29, 2001.

With reference to the above Korean Patent Laid-open Publication No. 2001-81876, an electronic commerce operator evaluates the credit status of registered members using the Internet on the basis of a prescribed reference, and issues the Internet electronic check to valid members on the basis of the evaluated result. In this case, the electronic commerce operator differently provides a face value or available money limit of the electronic check for each member on the basis of credit status information of the members such that the used amount of money of the electronic check in payment for purchase commodities can be paid to the electronic commerce operator.

However, the above conventional technique related to the electronic check requires a long time for issuing such check owing to a complicated check issuing procedure, because an issuer of a check is a financial company instead of a client. Further, the conventional technique has another disadvantage in that a client cannot freely issue an electronic check.

In conclusion, it is necessary for an electronic check system to adopt a client as an issuer such that the issuer easily and quickly issues an electronic check. Also, it is necessary for the electronic check system to transmit the issued electronic check to a payee via an E-mail using a P2P method such that secure remittance/settlement services are established.

### SUMMARY OF THE INVENTION

Therefore, the present invention has been made in view of the above problems, and it is an object of the present invention to provide a method for issuing and settling an electronic check by adopting a client as an issuer in such a way that the electronic check is quickly issued.

It is another object of the present invention to provide a method for issuing and settling an electronic check by transmitting an issued electronic check to a payee via an E-mail using a P2P method in such a way that it establishes secure remittance/settlement services.

In accordance with one aspect of the present invention, the above and other objects can be accomplished by the provision of a method for issuing and settling an electronic check executable in an electronic check management server, comprising the steps of: a) performing electronic check issuance; and b) performing electronic check settlement, said step (a) including the steps of: a1) receiving electronic check issuance request information from an issuer computer over a network; a2) transmitting an electronic check template to the issuer computer upon receiving the electronic check issuance request information; a3) receiving electronic check issuance information from the issuer computer; and a4) storing/registering the electronic check issuance information in a database, and said step (b) including the steps of: b1) receiving an electronic check from a payee computer; b2) transferring the amount of money marked on the electronic check to an account contained in membership registration information of a payee; and b3) transmitting a settlement receipt to the payee computer.

In accordance with another aspect of present invention, there is provided a method for issuing and settling an electronic check executable in an electronic check management server comprising the step of: c) performing a user registration function, said step (c) including the steps of: c1) receiving encryption user registration information and a user public key from an issuer computer or a payee computer; c2) decrypting the encryption user registration information and the encryption user public key with a private key of an electronic check management server; c3) conducting a user registration transaction according to the user registration information, and generating/storing a public key certificate of a corresponding user; and c4) transmitting user registration confirmation information and the public key certificate to the issuer computer or payee computer.

In accordance with a still another aspect of present invention, there is provided a method for issuing and settling an electronic check executable in an issuer computer, comprising the step of: a) performing electronic check issuance, said step (a) including the steps of: a1) transmitting electronic check issuance request information to an electronic check management server; a2) receiving an electronic check template from the electronic check management server according to the electronic check issuance request information; a3) issuing an electronic check using the electronic check template; a4) transmitting the electronic check issuance information to the electronic check management server; and a5) transmitting the electronic check issued by the step (a3) to a payee's E-mail address contained in electronic check issuance information as payment for purchasing commodities provided by a payee or accessing an arbitrary service provided by a payee.

In accordance with a still another aspect of present invention, there is provided a method for issuing and settling an electronic check executable in a payee computer, comprising the step of: a) performing electronic check settlement, said step (a) including the steps of: a1) receiving an electronic check via an E-mail; a2) transmitting the electronic check to an electronic check management server; and a3) receiving a settlement receipt from the electronic check management server which transfers the amount of money marked on the electronic check to an account of a payee.

In accordance with a still another aspect of present invention, there is provided a method for issuing and settling an electronic check comprising the step of: a) performing a user registration function executable in an issuer computer or a payee computer, said step (a) including the steps of: a1) receiving user registration information from a key entry unit of a payee computer; a2) generating and storing encryption keys being a user private key and a user public key; a3) encrypting the user registration information and the user public key with a public key of an electronic check management server, and transmitting them; a4) receiving user registration confirmation information and a user public key certificate from the electronic check management server; and a5) storing the user private key created by the step (a1) and the user public key certificate issued by the step (a4).

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating a conceptual diagram of an electronic check system in accordance with a preferred embodiment of the present invention;

FIG. 2 is an exemplary electronic check template in accordance with a preferred embodiment of the present invention;

FIG. 3 is a flow chart illustrating a user registration module executable in an issuer computer or a payee computer applied to a method for issuing and settling an electronic check in accordance with a preferred embodiment of the present invention;

FIG. 4 is a flow chart illustrating a user registration module executable in an electronic check settlement server applied to a method for issuing and settling an electronic check in accordance with a preferred embodiment of the present invention;

FIG. 5 is a flow chart illustrating an electronic check issuance module executable in an electronic check settlement server applied to a method for issuing and settling an electronic check in accordance with a preferred embodiment of the present invention;

FIG. 6 is a flow chart illustrating an electronic check issuance module executable in an issuer computer applied to a method for issuing and settling an electronic check in accordance with a preferred embodiment of the present invention;

FIG. 7 is a flow chart illustrating an electronic check settlement module executable in a payee computer applied to a method for issuing and settling an electronic check in accordance with a preferred embodiment of the present invention; and

FIG. 8 is a flow chart illustrating an electronic check settlement module executable in an electronic check management server applied to a method for issuing and settling an electronic check in accordance with a preferred embodiment of the present invention.

### DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

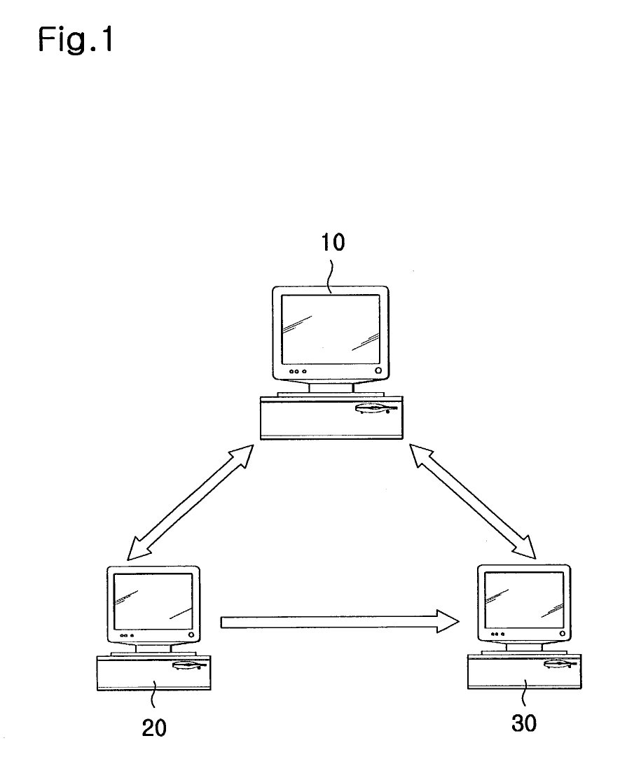

FIG. 1 is a view illustrating a conceptual diagram of an electronic check system in accordance with a preferred embodiment of the present invention.

Referring to FIG. 1, an electronic check system is comprised of an electronic check management server 10, an issuer computer 20, and a payee computer 30. The issuer computer 20 and the payee computer 30 function as a plurality of clients connected to the electronic check management server 10 over a network.

The electronic check management server 10 is administered by a bank of an electronic check issuer, and authorizes the electronic check issuer to issue an electronic check on condition that the electronic check issuer registers as a member in the server 10 through the use of a prescribed membership registration procedure.

Also, the electronic check management server 10 transmits an electronic check template needed to issue an electronic check to an issuer. The electronic check template, which is one kind of check book being softwarely provided from the electronic check management server 10, is displayed on a computer screen of the issuer. The issuer inputs registration request information on the electronic check template to issue an electronic check.

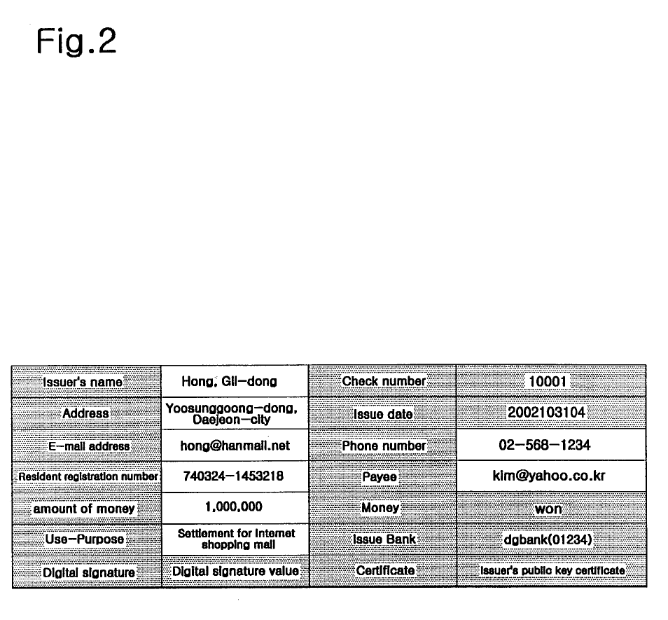

FIG. 2 is an exemplary electronic check template in accordance with a preferred embodiment of the present invention. In more detail, the issuer inputs the registration request information on while-colored parts shown in FIG. 2.

In the meantime, the electronic check management server 10 determines whether forgery, alteration or double-spending of electronic check occurs using the mechanism of a PKI (Public Key Infrastructure)-based digital signature, conducts settlement of the electronic check between an issuer and a payee by transfer to the account, and makes out a settlement receipt.

Describing the PKI-based digital signature mechanism in more detail, in the case where a sender encrypts arbitrary data having a digital signature signed by his or her private key through the use of a public key of a receiver and transmits the encryption data, the receiver decrypts the encryption data with his or her private key, confirms the digital signature using his or her public key, and finally determines whether a fraudulent modification of the data is detected using a hash value contained in the transmitted encryption data. Briefly, the aforementioned PKI-based digital signature mechanism is one of a variety of data encryption techniques.

The issuer computer 20 issues an electronic check upon receiving an electronic check template from the electronic check management server 10, and transfers the issued electronic check to an E-mail address of a corresponding payee as payment for purchasing commodities provided by the payee or accessing an arbitrary service provided by the payee.

The payee computer 30 transmits the electronic check to the electronic check management server 10 to request settlement, and receives a settlement receipt from the electronic check management server 10 on condition that a transfer account transaction is performed to an account of a corresponding payee.

In accordance with the inventive method for issuing and settling an electronic check, the electronic check management server 10 includes a user registration module, an electronic check issuance module, and an electronic check settlement module that are respectively executable by software. The issuer computer 20 includes a user registration module and an electronic check issuance module that are respectively executable by software. The payee computer 20 includes a user registration module and an electronic check settlement module that are respectively executable by software.

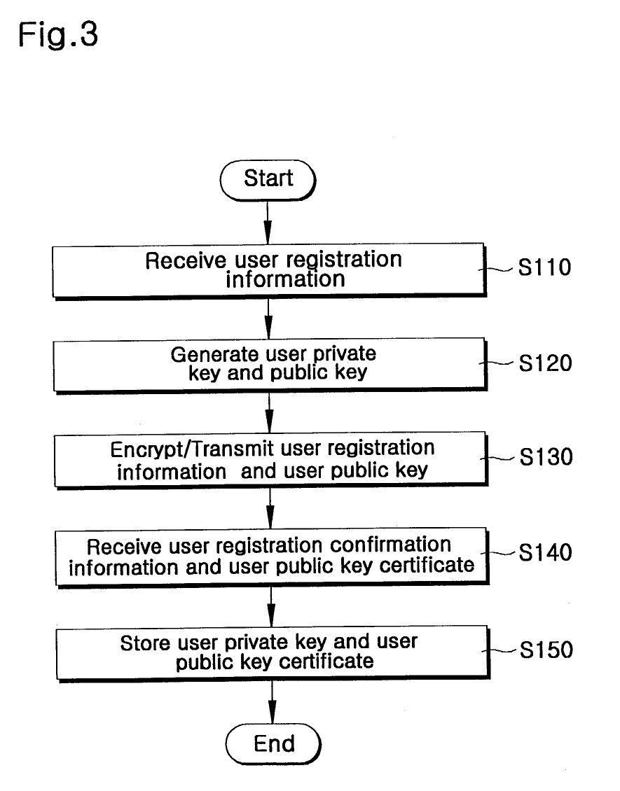

FIG. 3 is a flow chart illustrating a user registration module executable in an issuer computer or a payee computer applied to a method for issuing and settling an electronic check in accordance with a preferred embodiment of the present invention.

The user registration module described in FIG. 3 relates to a user registration procedure for issuing or settling an electronic check, and is executed in an issuer computer or a payee computer.

Referring to FIG. 3, the user registration module executable in the issuer computer or the payee computer includes a user registration information reception step S110, an encryption key generation step S120, a user registration information transmission step S130, a certificate reception step S140, and a step S150 for storing the encryption key and the certificate.

The user registration information reception step S110 receives user registration information comprised of a name, an address, a resident registration number, and an E-mail address through the use of a key entry unit of the issuer computer or the payee computer.

In more detail, to obtain authority for issuing and settling an electronic check, i.e., to obtain membership qualifications, the user registration information reception step S110 receives user registration information to be transmitted to an electronic check management server through the use of a key entry unit of the issuer computer or the payee computer, and receives the user registration information comprised of a name, an address, a resident registration number, and an E-mail address through a membership registration request form.

Preferably, the user registration information may include a user ID and password for gaining access to an electronic check management server.

The encryption key generation step S120 generates a private key and public key of a user.

In more detail, the encryption key generation step S120 generates user's private and public keys needed to conduct an encryption function for ensuring integrity, authenticity, and confidentiality of transmission data.

Therefore, in the case where a sender encrypts arbitrary data having a digital signature signed by his or her private key through the use of a public key of a receiver and transmits the encryption data, the receiver decrypts the encryption data using his or her private key, confirms the digital signature using his or her public key, and finally determines whether a fraudulent modification of the data is detected using a hash value contained in the transmitted encryption data. Briefly, the aforementioned PKI-based digital signature mechanism is one of a variety of data encryption techniques.

In the meantime, a public key of the electronic check management server provided in the form of a certificate by software is contained in a user registration module mounted into an issuer computer or a payee computer in such a way that it is adapted to encrypt data transmitted to a management server. It is desirable that a public key of another user registered in the management server is received from the electronic check management server, but it may be affixed to arbitrary data received from the above another user.

The user registration information transmission step S130 encrypts the user registration information and the user public key using a public key of the electronic check management server, and then transmits the encryption user registration information and the encryption user public key to the electronic check management server.

In more detail, the user registration information transmission step S130 transmits a public key to the electronic check management server. The public key is adapted to decrypt the user registration information for membership registration and the encryption data received at the electronic check management server from a corresponding user computer. In this case, the user registration information and the public key are encrypted with a public key of the electronic check management server to ensure integrity, authenticity, and confidentiality of transmission data.

Thereafter, the encryption user registration and the encryption public key of user are decrypted in the electronic check management server receiving them in future through the use of a private key of the electronic check management server.

The certificate reception step S140 receives user registration confirmation information and a user public key certificate from the electronic check management server.

In more detail, in the case where the electronic check management server receiving the user registration information and the user pubic key encrypted in the above step S130 establishes membership registration, the user registration confirmation information is generated. Also, the user public key certificate is adapted to verify the validity of a digital signature contained in the transmission data from the user. Under this condition, the certificate reception step S140 receives the user registration confirmation information and the user public key certificate from the electronic check management server.

The storing step S150 is adapted to store the private key generated in the encryption key generation step S120 and the public key certificate issued by the electronic check management server in the certificate reception step S140. The private key is encrypted with a password entered by the user to maintain confidentiality of data such that the data can be securely stored in the step S150.

In brief, the user registration module executable in an issuer computer or a payee computer receives user registration information from a key entry unit of the issuer computer or the payee computer in the user registration information reception step S110, generates and stores a user private key and a user public key in the encryption key generation step S120, encrypts and transmits the user registration information and the user public key in the user registration information transmission step S130, receives user registration confirmation information and a user public key certificate from an electronic check management server in the certificate reception step S140, and finally stores the user private key and the user public key certificate in the storing step S150.

In this way, such public key for verifying the validities of user registration information and digital signature used for issuing and settling an electronic check is authenticated.

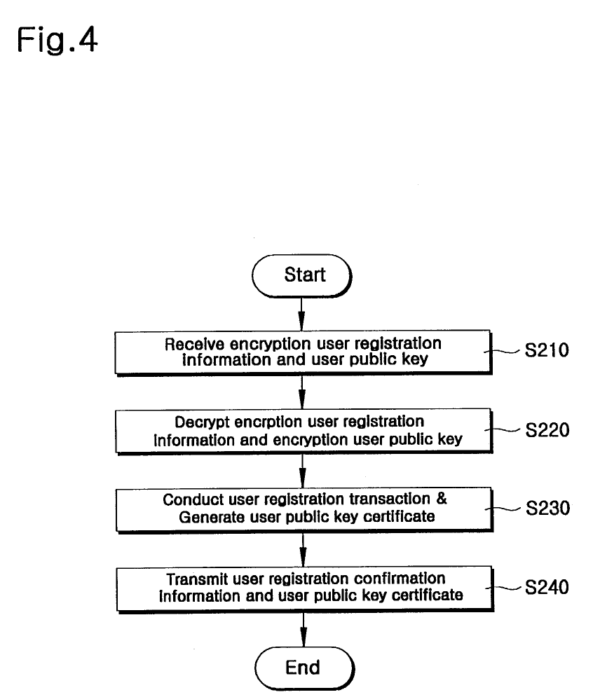

FIG. 4 is a flow chart illustrating a user registration module executable in an electronic check settlement server applied to a method for issuing and settling an electronic check in accordance with a preferred embodiment of the present invention.

The user registration module described in FIG. 4 relates to a user registration procedure for issuing or settling an electronic check, and is executed in an electronic check management server.

Referring to FIG. 4, the user registration module executable in the electronic check settlement server includes a user registration information reception step S210, a decryption step S220, a membership registration transaction step S230, and a certificate transmission step S240.

The user registration information reception step S210 receives encryption user registration information and an encryption user public key from an issuer computer or a payee computer.

In more detail, the user registration information reception step S210 receives the encryption user registration information and the encryption user public key that are transmitted from the aforementioned user registration information transmission step S130 shown in FIG. 3.

The decryption step S220 decrypts the encryption user registration information and the encryption user public key with a private key of an electronic check management server.

In more detail, the decryption step S220 decrypts and interprets the user registration information and the user public key, that have been encrypted with a public key of the electronic check management server in the user registration information transmission step S130 shown in FIG. 3, with a private key of an electronic check management server.

The membership registration transaction step S230 performs a user registration transaction according to the user registration information.

In more detail, the membership registration transaction step S230 registers a corresponding user as a member according to the user registration information decrypted in the aforementioned decryption step S220, stores the registered information, generates user registration confirmation information, generates a user certificate for verifying the validity of a digital signature contained in reception data transmitted from a computer of the corresponding user, and finally stores the user certificate in a database.

The certificate transmission step S240 transmits the user registration confirmation information and a user public key certificate to an issuer computer or a payee computer.

In more detail, the certificate transmission step S240 transmits registration confirmation information of a user registered as a member and a public key certificate to an issuer computer or a payee computer. Herein, the public key certificate is adapted to verify the validity of a digital signature contained in reception data received from the issuer computer or the payee computer.

In brief, the user registration module executable in an electronic check settlement server receives encryption user registration information and a user public key from the issuer computer or the payee computer in the user registration information reception step S210, decrypts the encryption user registration information and the encryption user public key with a private key of the electronic check management server in the decryption step S220, conducts a user registration transaction according to the decryption user registration information and generates/stores a public key certificate of a corresponding user in the membership registration transaction step S230, and transmits user registration confirmation information and a user public key certificate to a corresponding issuer computer or payee computer in the certificate transmission step S240.

In this way, such public key for verifying the validities of user registration information and digital signature used for issuing and settling an electronic check is authenticated.

Transmission/reception data among the electronic check management server 10, the issuer computer 20 and the payee computer 30 is encrypted by the PKI-based digital signature mechanism, but its detailed description will be omitted below.

Describing the PKI-based digital signature mechanism in more detail, in the case where a sender encrypts arbitrary data having a digital signature signed by his or her private key through the use of a public key of a receiver and transmits the encryption data, the receiver decrypts the encryption data with his or her private key, confirms the digital signature using his or her public key, and finally determines whether a fraudulent modification of the data is detected using a hash value contained in the transmitted encryption data.

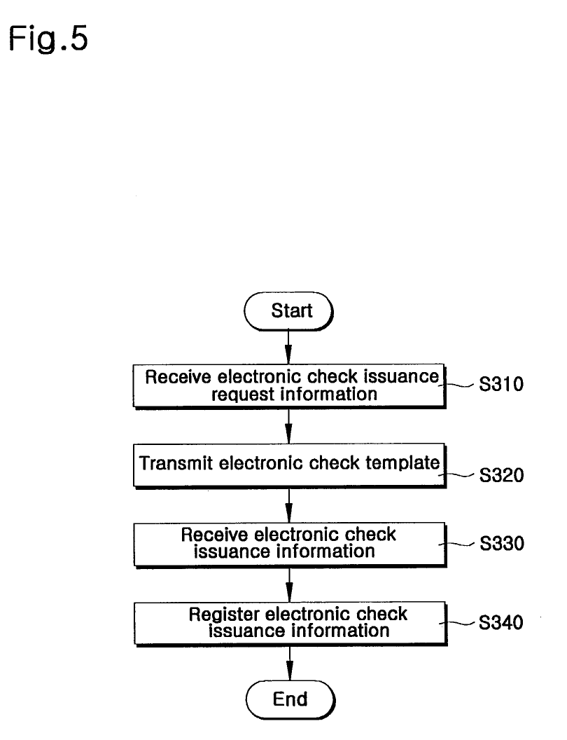

FIG. 5 is a flow chart illustrating an electronic check issuance module executable in an electronic check settlement server applied to a method for issuing and settling an electronic check in accordance with a preferred embodiment of the present invention.

The electronic check issuance module described in FIG. 5 is an electronic check issuance procedure executed in an electronic check management server for electronic check issuance.

Referring to FIG. 5, the electronic check issuance module executable in the electronic check settlement server includes an electronic check issuance request information reception step S310, a template transmission step S320, an electronic check issuance information reception step S330, and an electronic check issuance information registration step S340.

The electronic check issuance request information reception step S310 receives request information for issuing an electronic check from an issuer computer having access to the electronic check management server over a network.

The issuer inputs his or her ID and password pre-assigned in a membership registration procedure through the use of his or her own issuer computer, and thus gains access to the electronic check management server. Then, the issuer transmits electronic check issuance request information to the electronic check management server. Therefore, the electronic check management server receives the electronic check issuance request information in the above step S310.

The template transmission steps S320 transmits an electronic check template to a corresponding issuer computer according to the received electronic check issuance request information.

In more detail, the electronic check management server transmits an electronic check template needed for electronic check issuance to a corresponding issuer computer in the template transmission step S320 according to the electronic check issuance request information received in the electronic check issuance request information reception step 310.

The electronic check template, which is one kind of check book being softwarely provided from the electronic check management server, is displayed on a computer screen of the issuer. The issuer enters registration request information on the electronic check template to issue an electronic check.

The electronic check issuance information reception step S330 receives electronic check issuance information from a corresponding issuer computer.

In more detail, the electronic check issuance information reception step S330 receives such electronic check issuance information having various kinds of information from a corresponding issuer computer. The electronic check issuance information is comprised of an issuer's name, an issuer's address, an issuer's resident registration number, an issuer's E-mail address, an issuer's phone number, a face value, a payee's E-mail address, an issued electronic check number, an electronic check issuance date, and an electronic check issuance bank.

The electronic check issuance information registration step S340 stores the electronic check issuance information in a database such that the electronic check issuance information registration is established.

In more detail, the electronic check issuance information registration step S340 stores the electronic check issuance information created by an issuer so that it can verify the validity of a corresponding electronic check in case of receiving a settlement request signal from a payee who will receive the corresponding electronic check in future.

In brief, the electronic check issuance module executable in an electronic check settlement server receives electronic check issuance request information from an issuer computer networked to the electronic check settlement server in the electronic check issuance request information reception step S310, transmits an electronic check template to a corresponding issuer computer according to the received electronic check issuance request information in the template transmission step S320, receives electronic check issuance information from the corresponding issuer computer in the electronic check issuance information reception step S330, and finally stores and registers the received electronic check issuance information in a database in the electronic check issuance information registration step S340.

As a result, an issuer serving as a client becomes a subject for issuing such electronic check in such a way that the electronic check can be quickly issued.

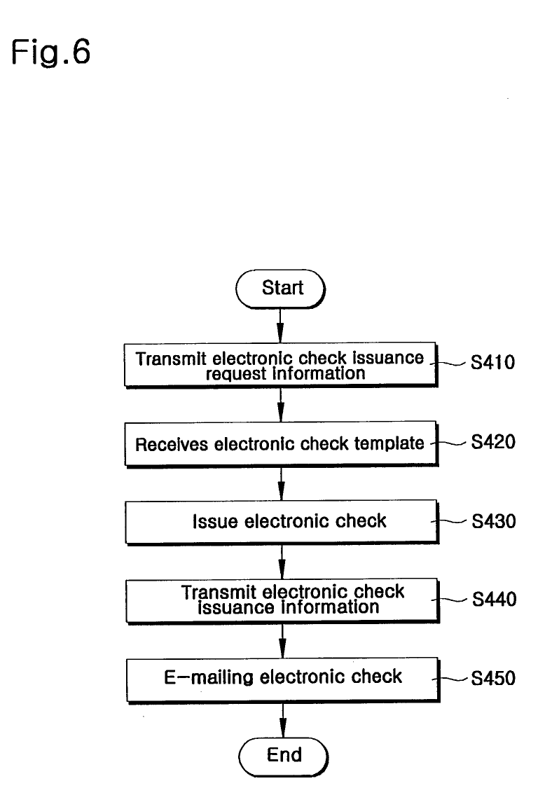

FIG. 6 is a flow chart illustrating an electronic check issuance module executable in an issuer computer applied to a method for issuing and settling an electronic check in accordance with a preferred embodiment of the present invention.

The electronic check issuance module described in FIG. 6 is an electronic check issuance procedure executed in an issuer computer for electronic check issuance.

Referring to FIG. 6, the electronic check issuance module executable in the issuer computer includes an electronic check issuance request information transmission step S410, a template reception step S420, an electronic check issuance step S430, an electronic check issuance information transmission step S440, and an electronic check transmission step S450.

The electronic check issuance request information transmission step S410 transmits electronic check issuance request information to an electronic check management server.

In more detail, in the electronic check issuance request information transmission step S410, the issuer inputs his or her ID and password pre-assigned in a membership registration procedure through the use of his or her own issuer computer, and thus gains access to the electronic check management server. Then, the issuer transmits electronic check issuance request information to the electronic check management server.

The template reception step S420 receives an electronic check template from the electronic check management server according to the received electronic check issuance request information.

In more detail, the template reception step S420 receives the electronic check template needed for electronic check issuance from the electronic check management server.

The electronic check issuance step S430 enters issuer's requisite information on the electronic check template to issue an electronic check. The issuer's requisite information is comprised of an issuer's name, an issuer's address, an issuer's resident registration number, an issuer's E-mail address, an issuer's phone number, a face value, and a payee's E-mail address.

The electronic check template is one kind of check book being softwarely provided from the electronic check management server, and is displayed on a computer screen of the issuer.

The issuer enters the issuer's requisite information on the electronic check template displayed on his or her computer, thereby issuing an electronic check.

The electronic check issuance information transmission step S440 transmits electronic check issuance information to the electronic check management server. The electronic check issuance information is comprised of an issuer's name, an issuer's address, an issuer's resident registration number, an issuer's E-mail address, an issuer's phone number, a face value, a payee's E-mail address, an issued electronic check number, an electronic check issuance date, and an electronic check issuance bank.

In more detail, the electronic check issuance information transmission step S440 stores the electronic check issuance information created by an issuer so that it can verify the validity of a corresponding electronic check in case of receiving a settlement request signal from a payee who will receive the corresponding electronic check in future.

As payment for purchasing commodities provided by the payee or accessing an arbitrary service provided by the payee, the electronic check transmission step S450 transmits the electronic check issued by the electronic check issuance step S430 to a payee's E-mail address contained in electronic check issuance information.

In more detail, in the electronic check transmission step S450, an issuer, who issues an electronic check for paying costs of purchasing commodities provided by the payee or accessing an arbitrary service provided by the payee, transmits the issued electronic check to a payee's E-mail address contained in electronic check issuance information via a P2P-based E-mail transmission method using his or her issuer computer.

In brief, the electronic check issuance module executable in an issuer computer transmits electronic check issuance request information to an electronic check management server in the electronic check issuance request information transmission step S410, receives an electronic check template from the electronic check management server according to the electronic check issuance request information in the template reception step S420, enters issuer's requisite information on the electronic check template to issue an electronic check in the electronic check issuance step S430, transmits the electronic check issuance information to the electronic check management server in the electronic check issuance information transmission step S440, and finally transmits the electronic check issued by the electronic check issuance step S430 to a payee's E-mail address contained in electronic check issuance information as payment for purchasing commodities provided by the payee or accessing an arbitrary service provided by the payee in the electronic check transmission step S450.

As a result, the issuer serving as a client becomes a subject for issuing such electronic check in such a way that the electronic check can be quickly issued.

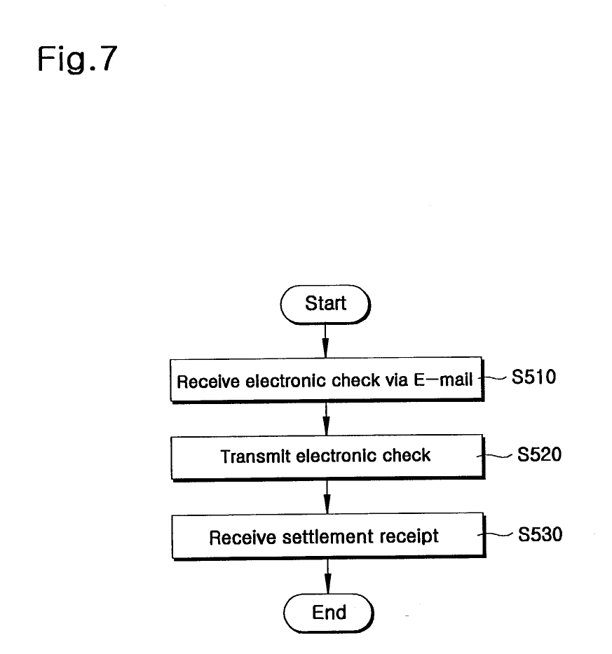

FIG. 7 is a flow chart illustrating an electronic check settlement module executable in a payee computer applied to a method for issuing and settling an electronic check in accordance with a preferred embodiment of the present invention.

The electronic check settlement module described in FIG. 7 is an electronic check settlement procedure executed in a payee computer for electronic check issuance.

Referring to FIG. 7, the electronic check settlement module executable in the payee computer includes an electronic check reception step S510, an electronic check transmission step S520, and a settlement receipt reception step S530.

The electronic check reception step S510 receives an electronic check via an E-mail.

In more detail, a payee receives an electronic check transmitted to a payee's E-mail address by an issuer via an E-mail tool such as an Outlook Express program.

The electronic check transmission step S520 transmits the received electronic check to the electronic check management server.

In this manner, the issuer issues an electronic check for settling the amount of charged money or costs of purchasing commodities provided by the payee or accessing an arbitrary service provided by the payee. Therefore, the issuer transmits the electronic check to the electronic check management server in the electronic check transmission step 520, thereby requesting settlement of the electronic check.

The settlement receipt reception step S530 receives a settlement receipt from the electronic check management server which transfers the amount of money marked on the electronic check to the account of a corresponding payee.

In more detail, the electronic check management server transfers the amount of money marked on the electronic check from a payee computer to the account of a corresponding payee such that it completes settlement of the electronic check, and finally deletes the electronic check.

The electronic check management server transmits a settlement receipt to a corresponding payee computer such that the payee computer receives the settlement receipt in the settlement receipt reception step S530.

In brief, the electronic check settlement module executable in a payee computer receives an electronic check via an E-mail in the electronic check reception step S510, transmits the received electronic check to an electronic check management server in the electronic check transmission step S520, and finally receives a settlement receipt from the electronic check management server which transfers the amount of money marked on the electronic check to the account of a corresponding payee.

As a result, an electronic check settlement module shown in FIG. 7 transmits the issued electronic check to the payee via an E-mail using a P2P method such that secure remittance/settlement services are effectively established.

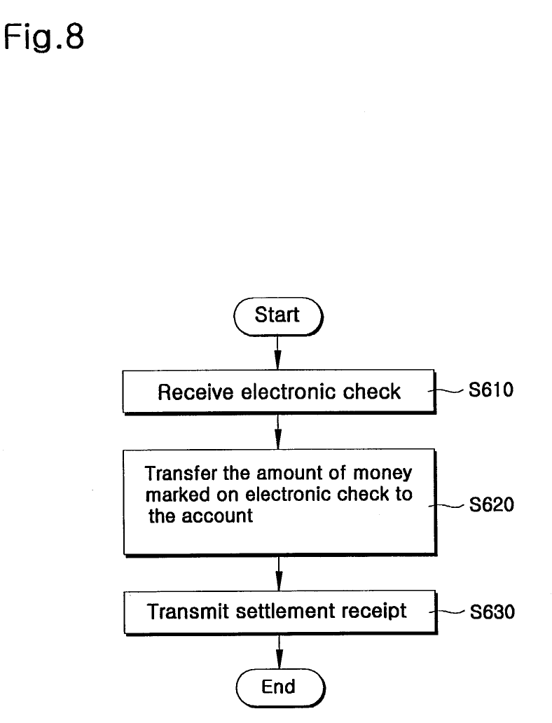

FIG. 8 is a flow chart illustrating an electronic check settlement module executable in an electronic check management server applied to a method for issuing and settling an electronic check in accordance with a preferred embodiment of the present invention.

The electronic check settlement module described in FIG. 8 is an electronic check settlement procedure executed in an electronic check management server for electronic check settlement.

Referring to FIG. 8, the electronic check settlement module executable in the electronic check management server includes an electronic check reception step S610, a settlement transaction step S620, and a settlement receipt transmission step S630.

The electronic check reception step S610 receives an electronic check from a payee computer.

In more detail, in the case where a payee receiving an electronic check received at his or her E-mail address requests settlement of the electronic check from an electronic check management server by transmitting the electronic check to the electronic check management server, the electronic check management server receives the electronic check in the electronic check reception step S610.

The settlement transaction step S620 transfers the amount of money marked on the electronic check to the account indicated in membership registration information of the payee.

In more detail, in the settlement transaction step S620, the electronic check management server verifies the validity of an electronic check received by the electronic check reception step S610. If it is determined that the electronic check is valid, the electronic check management server transfers the amount of money marked on the electronic check to a payee's account, makes out a settlement receipt, and finally deletes the electronic check.

The settlement receipt transmission step S630 transmits the settled receipt to a payee computer.

In more detail, a settlement receipt created by a settlement transaction completion of the electronic check management server is transmitted to a payee computer in such a way that the electronic check management server informs a payee of settlement transaction completion.

In brief, the electronic check settlement module executable in the electronic check management server receives an electronic check from a payee computer in the electronic check reception step S610, transfers the amount of money marked on the electronic check to the account indicated in membership registration information of the payee in the settlement transaction step S620, and finally transmits the settled receipt to a payee computer in the settlement receipt transmission step S630.

As a result, an electronic check settlement module shown in FIG. 8 transmits the issued electronic check to the payee via an E-mail using a P2P method such that secure remittance/settlement services are effectively established.

As apparent from the above description, a method for issuing and settling an electronic check in accordance with the present invention adopts a client as an electronic check issuer to quickly issue the electronic check, and transmits an issued electronic check to a payee via an E-mail using a P2P method, thereby establishing secure remittance/settlement services.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for issuing and settling an electronic check executable in an electronic check management server, comprising the steps of:
a) performing electronic check issuance; and
b) performing electronic check settlement, said step (a) including the steps of:
a1) receiving electronic check issuance request information from an issuer computer-over a network;
a2) transmitting an electronic check template to the issuer computer upon receiving the electronic check issuance request information;
a3) receiving electronic check issuance information from the issuer computer; and
a4) storing/registering the electronic check issuance information in a database, and said step (b) including the steps of:
b1) receiving an electronic check from a payee computer;
b2) transferring the amount of money marked on the electronic check to an account contained in membership registration information of a payee; and
b3) transmitting a settlement receipt to the payee computer.

2. The method as set forth in claim 1, further comprising the step of:
c) performing a user registration function, said step (c) including the steps of:
c1) receiving encryption user registration information and a user public key from an issuer computer or a payee computer;
c2) decrypting the encryption user registration information and the encryption user public key with a private key of an electronic check management server;
c3) conducting a user registration transaction according to the user registration information, and generating/storing a public key certificate of a corresponding user; and
c4) transmitting user registration confirmation information and the public key certificate to the issuer computer or payee computer.

3. A method for issuing and settling an electronic check executable in an issuer computer, comprising the step of:
a) performing electronic check issuance, said step (a) including the steps of:
a1) transmitting electronic check issuance request information to an electronic check management server;
a2) receiving an electronic check template from the electronic check management server according to the electronic check issuance request information;
a3) issuing an electronic check using the electronic check template;
a4) transmitting the electronic check issuance information to the electronic check management server; and
a5) transmitting the electronic check issued by the step (a3) to a payee's E-mail address contained in electronic check issuance information as payment for purchasing commodities provided by a payee or accessing an arbitrary service provided by a payee.

4. The method as set forth in claim 3, further comprising the step of:
b) performing a user registration function, said step (b) including the steps of:
b1) receiving user registration information from a key entry unit of an issuer computer;
b2) generating/storing encryption keys being a user private key and a user public key;
b3) encrypting the user registration information and the user public key with a public key of an electronic check management server, and transmitting them; and
b4) receiving user registration confirmation information and a user public key certificate from the electronic check management server.

5. A method for issuing and settling an electronic check executable in a payee computer, comprising the step of:
a) performing electronic check settlement, said step (a) including the steps of:
a1) receiving an electronic check via an E-mail;
a2) transmitting the electronic check to an electronic check management server; and
a3) receiving a settlement receipt from the electronic check management server which transfers the amount of money marked on the electronic check to an account of a payee.

6. The method as set forth in claim 5, further comprising the step of:
b) performing a user registration function, said step (b) including the steps of:
b1) receiving user registration information from a key entry unit of a payee computer;
b2) generating/storing encryption keys being a user private key and a user public key;
b3) encrypting the user registration information and the user public key with a public key of an electronic check management server, and transmitting them;
b4) receiving user registration confirmation information and a user public key certificate from the electronic check management server; and
b5) storing the user private key created by the step (b1) and the user public key certificate issued by the step (b4).
